(19) United States
(12) Patent Application Publication
(10) Pub. No.: US 2011/0298903 A1
(43) Pub. Date: Dec. 8, 2011

(54) Image Output Apparatus and Image Output Method

(76) Inventor: Takashi Inagaki, Inagi-shi (JP)

(21) Appl. No.: 13/079,632

(22) Filed: Apr. 4, 2011

(30) Foreign Application Priority Data
Jun. 8, 2010 (JP) 2010-131492

(51) Int. Cl. H04N 13/04

(52) U.S. Cl. 348/51; 348/E13.075

(57) ABSTRACT

According to one embodiment, an image output apparatus is provided. The image output apparatus includes: an image data order-change module configured to input images from a plurality of systems, to change the order of the images, and to output the images continuously; a glasses shutter controller configured to generate a signal synchronized to an output of the images; and a corrected image generation block configured to correct the images such that coloring of successive images approaches each other.

### CROSS REFERENCE TO RELATED APPLICATION(S)

The application is based upon and claims the benefit of priority from Japanese Patent Application No. 2010-131492 filed on Jun. 8, 2010; the entire content of which are incorporated herein by reference.

### FIELD

Embodiments described herein relate generally to an image output apparatus and an image output method for avoiding crosstalk in a multi-view system.

### BACKGROUND

Technology for generating 3D right-eye and left-eye images, such as in liquid crystal TVs, has been further employed to configure a multi-view system.

For example, a related art discloses the following technology. A right-eye image and a left-eye image, which correspond to a visual difference required to give the perception of 3D video, are alternately displayed by scanning modulated light on an image display screen of an image display section. A time division shutter is disposed between the image display screen and a viewer and has a right eye shutter and a left eye shutter capable of opening or shutting off plural partitioned regions on a region-by-region basis. The opening and closing of the time division shutter is controlled and synchronized to display on the image display section such that, when reproducing a right-eye image or left-eye image, only portions at the corresponding scan position of the modulated light of the right eye shutter or the left eye shutter, respectively, are open. Control is performed such that the open duration of the shutter is short enough for the 3D right-eye and left-eye images not to mix.

A technology is also desired for reducing crosstalk in multi-view systems that are very susceptible to crosstalk, but there is no known means to realize such a goal.

### BRIEF DESCRIPTION OF THE DRAWINGS

FIG. 1 is a explanatory diagram showing an external appearance of a digital television apparatus 111 according to an exemplary embodiment and showing a network system configured around the digital television apparatus 111;

FIG. 2 is a diagram showing a main signal processing system of the digital television apparatus 111;

FIG. 3 is a block diagram of a multi-view system showing the exemplary embodiment;

FIG. 4 is an explanatory diagram showing a flow of output data of a multi-view system of the exemplary embodiment;

FIG. 5 is an explanatory diagram showing another flow of output data in a multi-view system of the exemplary embodiment;

FIG. 6 is an explanatory diagram showing a corrected image generation block of the exemplary embodiment;

FIG. 7 is an explanatory diagram showing a flow of output data of a multi-view system employed in a related art;

FIG. 8 is a second explanatory diagram showing a flow of output data of a multi-view system employed in the related art; and

FIG. 9 is a flow chart of a multi-view system of the exemplary embodiment.

### DETAILED DESCRIPTION

In general, according to one exemplary embodiment, an image output apparatus is provided. The image output apparatus includes: an image data order-change module configured to input images from a plurality of systems, to change the order of the images, and to output the images continuously; a glasses shutter controller configured to generate a signal synchronized to an output of the images; and a corrected image generation block configured to correct the images such that coloring of successive images approaches each other.

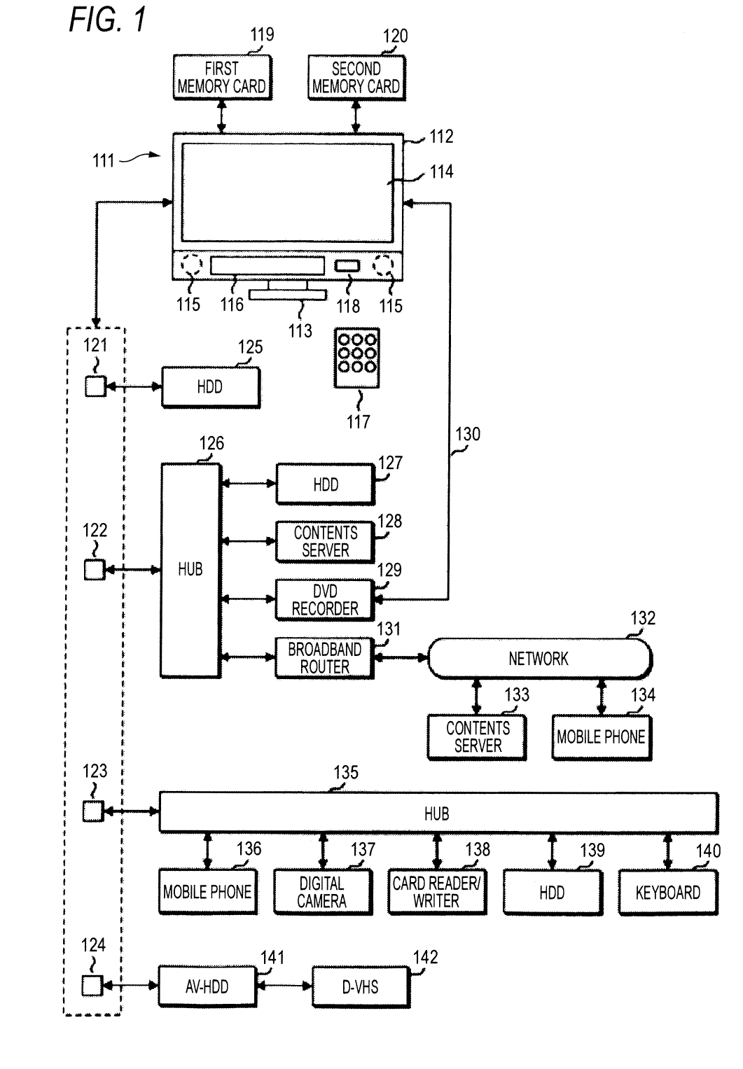

Explanation follows regarding an exemplary embodiment with reference to FIG. 1 to FIG. 9.

FIG. 1 is a diagram showing an external appearance of a digital television apparatus 111 provided with a network function which is a communication device according to the exemplary embodiment, together with a schematic illustration of an example of a network system configured around the digital television apparatus 111.

The digital television apparatus 111 is provided with a slim-style cabinet 112 and a support stand 113 that supports the cabinet 112 in an upright position. The cabinet 112 includes a flat-panel video display device 114, such as a Surface-conduction Electron-emitter Display (SED) panel or a liquid crystal display panel, speakers 115, an operation panel 116, and a light receiver 118 that receives operation data transmitted from a remote controller 117.

The digital television apparatus 111 has a detachable first memory card 119, such as a Secure Digital (SD) memory card, a Multimedia Card (MMC) or a memory stick, configured such that programs and photographs can be recorded to and replayed from the first memory card 119.

A second memory card (IC card) 120, stored for example with contract data, is also detachably provided to the digital television apparatus 111, such that data can be recorded to and replayed from the second memory card 120.

The digital television apparatus 111 is provided with a first Local Area Network (LAN) terminal 121, a second LAN terminal 122, a Universal Serial Bus (USB) terminal 123 and an i.LINK terminal 124.

The first LAN terminal 121 is employed as a LAN compatible HDD dedicated port, and is used for recording and replaying data by Ethernet (registered trademark) to and from a connected LAN compatible HDD 125, serving as Network Attached Storage (NAS).

The provision of the first LAN terminal 121 as a LAN compatible HDD dedicated port enables high-definition image quality program data to be stably recorded on the LAN compatible HDD 125, without being affected by other network environments, or network usage conditions.

The second LAN terminal 122 is employed as a general LAN compatible port using Ethernet (registered trademark). For example, the second LAN terminal 122 is used to connect devices such as a LAN compatible HDD 127, a contents server 128, a Digital Versatile Disk (DVD) recorder 129 with built-in HDD, to the television set 111 through a hub 126 to perform data transmission with the devices.

The contents server 128 is configured with a Universal Plug-and-Play (UPnP) compatible device having a function of operating as a contents server in a home-network, and equipped with a service for providing Uniform Resource Identifier (URI) data required for accessing contents.

Regarding the DVD recorder 129, since only control system data is communicated as digital data through the second LAN terminal 122, it is necessary to provide a dedicated analog transmission line 130 in order to transmit analog video and audio data to and from the digital television apparatus 111.

The second LAN terminal 122 is connected to a network 132 such as the Internet through a broadband router 131 connected to the hub 126, and data transmission, such as to and from a contents server 133 or a mobile phone 134, is performed through the network 132.

The contents server 133 is configured with a UPnP compatible device having a function of operating as a contents server, and equipped with a service for providing URI data required for accessing contents.

The USB terminal 123 is used as a general USB compatible port. For example, the USB terminal 123 is connected to USB devices such as a mobile phone 136, a digital camera 137, a card reader/writer 138 for memory cards, an HDD 139, and a keyboard 140 through a hub 135, and employed for data transmission to and from the USB devices.

The i.Link terminal 124 establishes serial connection, such as with an AV-HDD 141 or a digital (D)-video home system (VHS) 142, and is employed for data transmission to and from these devices.

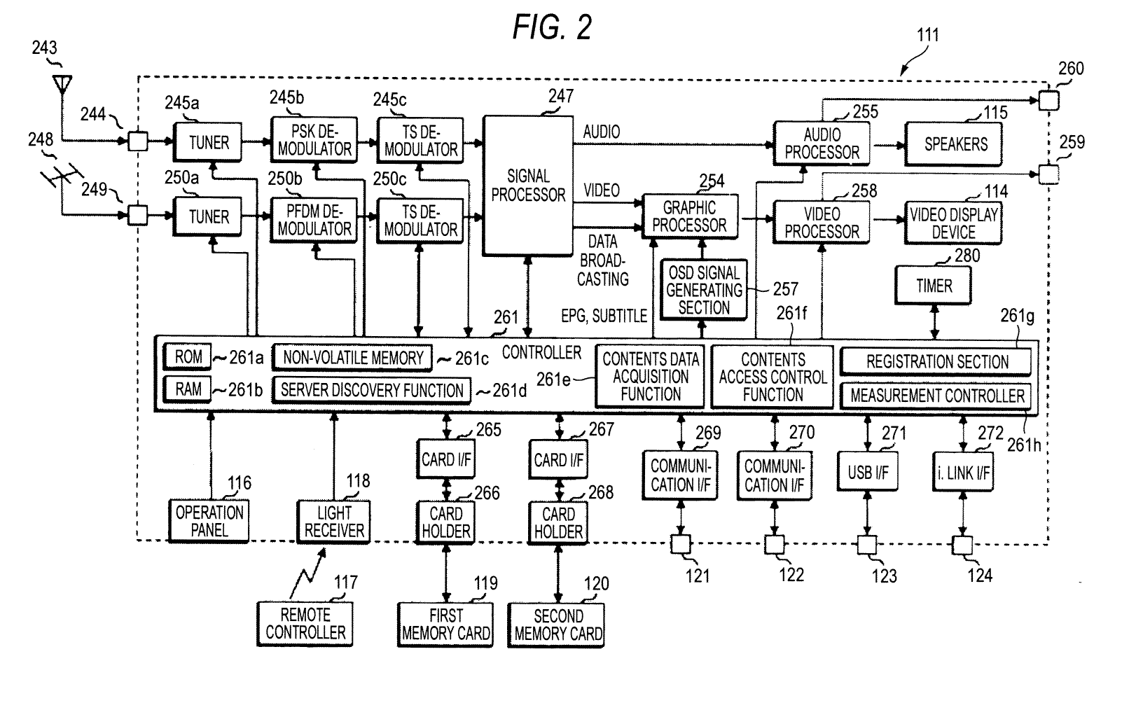

FIG. 2 shows a main signal processing system of the digital television apparatus 111.

A satellite digital television broadcast signal received by a BS/CS digital broadcasting receiving antenna 243 is supplied to a satellite digital broadcast tuner 245a through an input terminal 244.

The tuner 245a selects the broadcast signal for the desired channel by a control signal from a controller 261, and outputs the selected broadcast signal to a phase shift keying (PSK) demodulator 245b.

The PSK demodulator 245b demodulates the broadcast signal selected by the tuner 245a by a control signal from the controller 261, obtains a transport stream (TS) including the desired program, and outputs the transport stream to a TS demodulator 245c.

Under control of a control signal from the controller 261, the TS demodulator 245c performs TS demodulation processing on a TS multiplexed signal, and outputs a Packetized Elementary Stream (PES), obtained by de-packeting the digital video and audio signals of the desired program, to a STD buffer 247f in a signal processor 247.

The TS demodulator 245c outputs section data transmitted by digital broadcast to a section processor 247h in the signal processor 247.

A terrestrial digital television broadcast signal received by a terrestrial broadcasting receiving antenna 248 is supplied to a terrestrial digital broadcasting tuner 250a through an input terminal 249.

Under control of a control signal from the controller 261, the tuner 250a selects the broadcast signal of the desired channel and outputs the selected broadcast signal to an orthogonal frequency division multiplexing (OFDM) demodulator 250b.

Under control of a control signal from the controller 261, the OFDM demodulator 250b demodulates the broadcast signal selected by the tuner 250a, obtains a transport stream containing the desired program, and outputs the transport stream to a TS demodulator 250c.

Under control of a control signal from the controller 261, the TS demodulator 250c performs TS demodulation processing on the TS multiplexed signal, and outputs a Packetized Elementary Stream (PES), obtained by de-packeting the digital video and audio signals of the desired program, to the STD buffer 247f in the signal processor 247.

The TS demodulator 250c outputs section data transmitted by digital broadcast to the section processor 247h.

During television viewing, the signal processor 247 selectively performs specific digital signal processing on digital video and audio signals supplied from the TS demodulator 245c and the TS demodulator 250c, respectively, and outputs the processed signals to a graphic processor 254 and an audio processor 255. During contents replaying, the signal processor 247 selects contents replaying signals input from the controller 261, subjects the signals to specific digital signal processing, and outputs the processed signals to the graphic processor 254 and the audio processor 255.

The controller 261 is input from the signal processor 247 with various data and electronic program guide (EPG) data for acquiring a program, program attribute data (such as a program schedule) and subtitle data (service data, SI and PSI).

The controller 261 performs image generation processing for displaying the EPG and subtitles from input data, and outputs the generated image data to the graphic processor 254.

From the section data input from the TS demodulator 245c (250c), the section processor 247h outputs to the controller 261 the various data for acquiring a program, such as electronic program guide (EPG) data, program attribute data (such as program schedule) and subtitle data (service data, SI and PSI).

The graphic processor 254 has functionality for combining (1) a digital video signal supplied from an AV decoder 247g in the signal processor 247, (2) an On Screen Display (OSD) signal generated in an OSD signal generating section 257, (3) image data from data broadcast, and/or (4) EPG, subtitle signal and/or GUI screen generated by the controller 261. The graphic processor 254 outputs the combination to a video processor 258.

When displaying subtitles from subtitle broadcast, under control from the controller 261 and based on subtitle data, the graphic processor 254 performs processing to superimpose the subtitle data on the video signal.

The digital video signal output from the graphic processor 254 is supplied to the video processor 258. The video processor 258 converts the input digital video signal to an analogue video signal of a format displayable with the video display device 114, then outputs the analogue video signal for display on the video display device 114 and also leads the signal to external sections via an output terminal 259.

The audio processor 255 converts the input digital audio signal to an analogue audio signal of a format replayable by the speakers 115, then outputs the analogue audio signal to replay audio on the speakers 115 and also leads the signal to external sections via an output terminal 260.

The controller 261 takes overall controls of all of the operations in the digital television apparatus 111, including the various reception operations described above. The controller 261 is internally installed with a Central Processor Unit (CPU), receives operation data from the operation panel 116, receives operation data transmitted from the remote controller 117 through the light receiver 118, and controls the various respective sections so as to reflect the operational contents.

The controller 261 mainly utilizes a Read Only Memory (ROM) 261a in which a control program executed by the CPU is stored, a Random Access Memory (RAM) 261b which supplies a working area for the CPU, and a non-volatile memory 261c in which various kinds of setting data and control data are stored.

The controller 261 is connected to a card holder 266 through a card interface (I/F) 265. The first memory card 119 is mountable in the card holder 266. The controller 261 can thereby perform data transmission to and from the first memory card 119 mounted in the card holder 266 through the card I/F 265.

The controller 261 is connected to a card holder 268 through a card I/F 267. The second memory card 120 is mountable in the card holder 268. The controller 261 can thereby perform data transmission to and from the second memory card 120 mounted in the card holder 268 through the card I/F 267.

The controller 261 is connected to the first LAN terminal 121 through a communication I/F 269. The controller 261 can thereby perform data transmission to and from the LAN compatible HDD 125 connected to the first LAN terminal 121 through the communication I/F 269. When doing so, the controller 261 has a Dynamic Host Configuration Protocol (DHCP) server function, and the controller 261 controls while allocating an Internet Protocol (IP) address to the LAN compatible HDD 125 connected to the first LAN terminal 121.

The controller 261 is connected to the second LAN terminal 122 through a communication I/F 270. The controller 261 can perform data transmission to and from each of the devices (see FIG. 1) connected to the second LAN terminal 122 through the communication I/F 270.

The controller 261 is connected to the USB terminal 123 through the USB I/F 271. The controller 261 can thereby perform data transmission to and from each of the devices (see FIG. 1) connected to the USB terminal 123 through the USB I/F 271.

The controller 261 is connected to the i.Link terminal 124 through an i.Link I/F 272. The controller 261 can thereby perform data transmission to and from each of the devices (see FIG. 1) connected to the i.Link terminal 124 through the i.Link I/F 272.

In the exemplary embodiment, a registration file is stored in the LAN compatible HDD 125 listing storage IDs (including IP address, device name) that have been allocated to the HDD 125, the HDD 127, the contents server 128 and the DVD recorder 129, respectively, during initial registration.

The respective storage IDs of the LAN compatible HDD 125, HDD 127, contents server 128 and DVD recorder 129 are stored in the non-volatile memory 261c.

The controller 261 is equipped with the following functions relating to the embodiments described herein: (1) a UPnP utilizing server discovery function 261d; (2) a UPnP utilizing contents data acquisition function 261e; and a contents access control function 261f.

In (1), the controller 261 uses the server discovery function 261d to discover UPnP compatible devices on the network using a UPnP discovery function. For example, the server discovery function 261d employs a UPnP discovery function to discover the contents server 128.

In (2), the controller 261 uses the contents data acquisition function 261e to employ a UPnP control function to control UPnP compatible devices, and acquirers URI data required for accessing contents in UPnP compatible devices. For example, the contents data acquisition function 261e controls the contents server 128, and acquires from the contents server 128 URI data required for accessing contents stored in the HDD in the contents server 128.

In (3), the controller 261 uses the contents access control function 261f to determine whether access to contents is possible/not possible based on the IP address data of the servers acquired by the server discovery function 261d, the IP address data obtained from URI data acquired by the contents data acquisition function 261e, and the IP address and netmask allocated to the second LAN terminal 122 of the digital television apparatus 111. The controller 261 permits contents access when access is determined to be possible. However, when determined that access is not possible, the controller 261 displays on the video display device 114 by OSD that access is not permitted.

The controller 261 also has a registration module 261g for registering recording-replaying devices on the network that perform recording and replaying processing, and a measurement controller 261h for measuring the recording speed at which a file is recorded at a given recording and replaying position.

Explanation follows regarding connecting the HDD 139, which is a USB device, using the USB terminal 123, which is a general USB compatible port, when performing recording and replaying to and from the HDD 139 (referred to below as USB HDD 139).

However, the exemplary embodiment is not limited to USB, and application may be made of another interface, such as IEEE 1394 or a LAN-HDD.

Note that while in FIG. 1 the USB HDD 139 is employed through the hub 135 with plural USB devices, preferably a dedicated port is allocated in order to be able to prevent influence from other devices.

The exemplary embodiment is applied to a multi-view system employing shutter glasses.

There are 3D television in which images for right eye and left eye use are output under time division from the same image output apparatus, and shutter glasses are used to view the corresponding right eye and the left eye respective images. However, by employing this mechanism, a system (referred to below as multi-view system) can also be configured in which a desired image can be viewed, by outputting completely different images under time division and using the shutter glasses. Configurations for such systems are known. However, at the implementation stage of such systems, when the coloring of the two images are significantly different from each other, residual image of one image is superimposed on the other image due to display being performed under time division, with a detriment to visibility. This phenomenon is referred so as crosstalk. In 3D television the coloring of the two images is only slightly different from each other, however there is concern of significant crosstalk arising between images in a multi-view system.

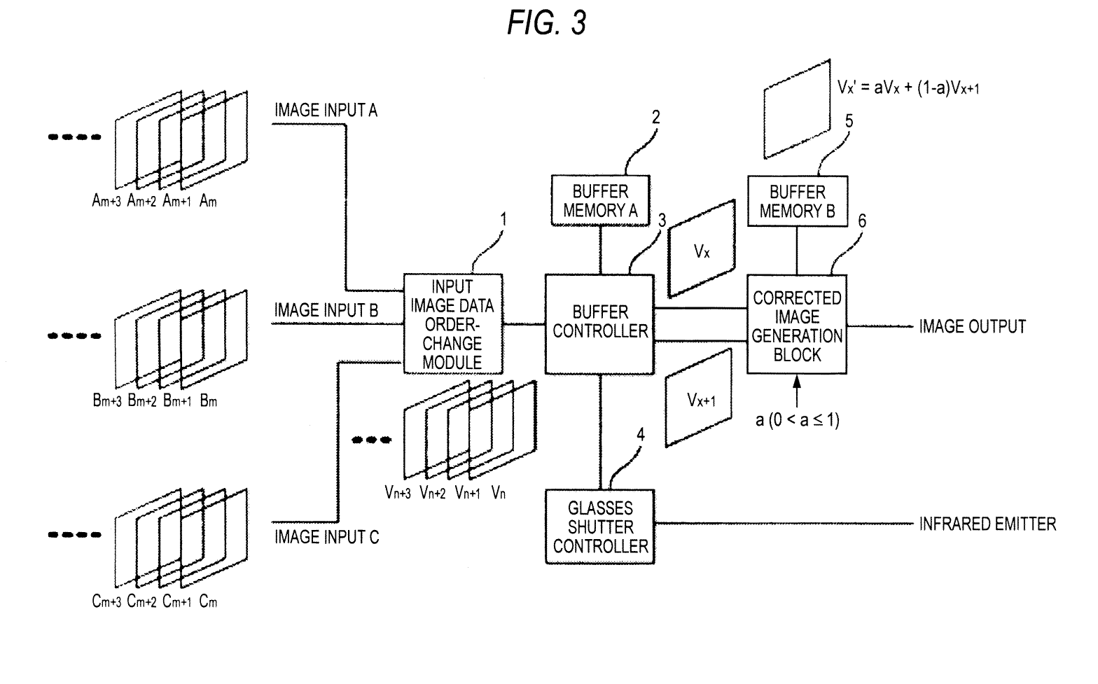

FIG. 3 shows a block diagram of a multi-view system of an exemplary embodiment. The multi-view system is provided with an input image data order-change module 1, a buffer memory A 2, a buffer controller 3, a glasses shutter controller 4, a buffer memory B 5 and a corrected image generation block 6. The glasses shutter controller 4 transmits a control signal synchronized with data for transmission to an infrared emitter, and is an important configuration feature for functions relating to the controller 261 and the video processor 258.

The input image data order-change module 1 is input with plural image inputs, for example an image input A, an image input B, and an image input C, changes the order thereof, and then outputs the images. When the plural images arrive, such as Aₘ, Aₘ₊₁, Aₘ₊₂, Aₘ₊₃ for the image input A, Bₘ, Bₘ₊₁, Bₘ₊₂, Bₘ₊₃ for the image input B, and Cₘ, Cₘ₊₁, Cₘ₊₂, Cₘ₊₃ for the image input C, in these respective sequences, the input image data order-change module 1, for example, outputs Vₙ=Aₘ, Vₙ₊₁=Bₘ, Vₙ₊₂=Cₘ, Vₙ₊₃=Aₘ₊₁.

The buffer memory A 2 is controlled by the buffer controller 3. The buffer controller 3 controls the glasses shutter controller 4 and outputs Vₓ and Vₓ₊₁ based on the output of the input image data order-change module 1.

As a characteristic portion of the exemplary embodiment, the corrected image generation block 6 outputs image Vₓ′ while controlling the buffer memory B 5. The corrected image generation block 6 computes intermediate values between each of the pixels of image data Vₓ transmitted at a given time, and each of the pixels of the image data Vₓ₊₁ next transmitted (for example, a normalized parameter α(0<α≦1) is multiplied by the current image, and (1−α) is multiplied by the next image, and the product thereof taken, i.e. Vₓ′=αVₓ+(1−α)Vₓ₊₁ . Note that if α=1 then this means no correction is performed). The corrected image generation block 6 then outputs the computed values to an image output apparatus (and/or stores the values in the buffer memory B 5 as required). By such correction, since the difference in coloring between the current image and the next image is reduced, a reduction in crosstalk can be achieved.

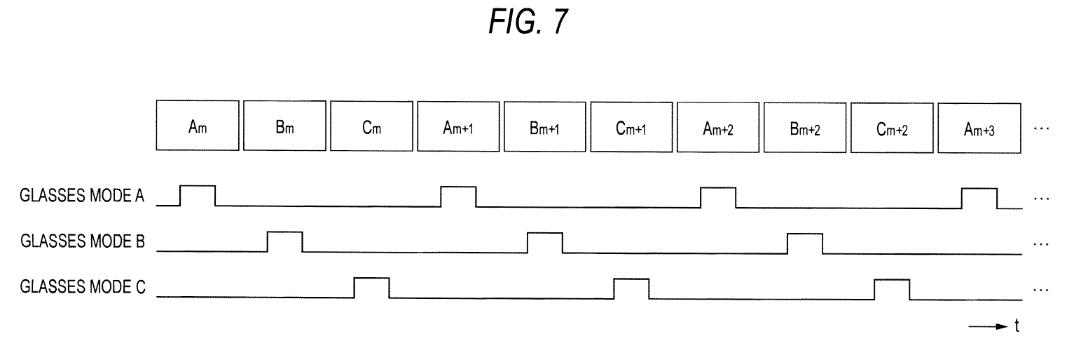

FIG. 7 shows a flow of output data of a conventional multi-view system. The horizontal axis shows the passage of time. The “glasses modes” here indicate opening of the glasses shutter to correspond to data of the image input A, the image input B and the image input C, respectively.

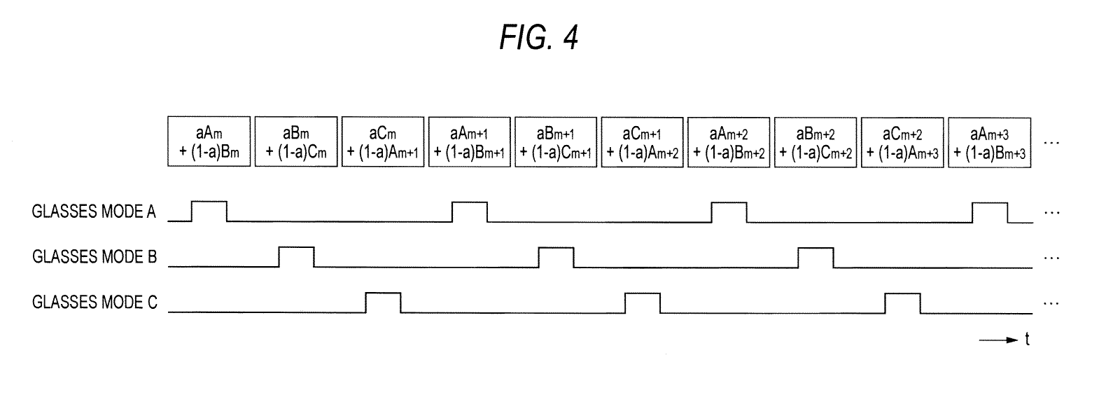

FIG. 4 is an improved version of FIG. 7. Both sets of image data are shown being corrected as described above.

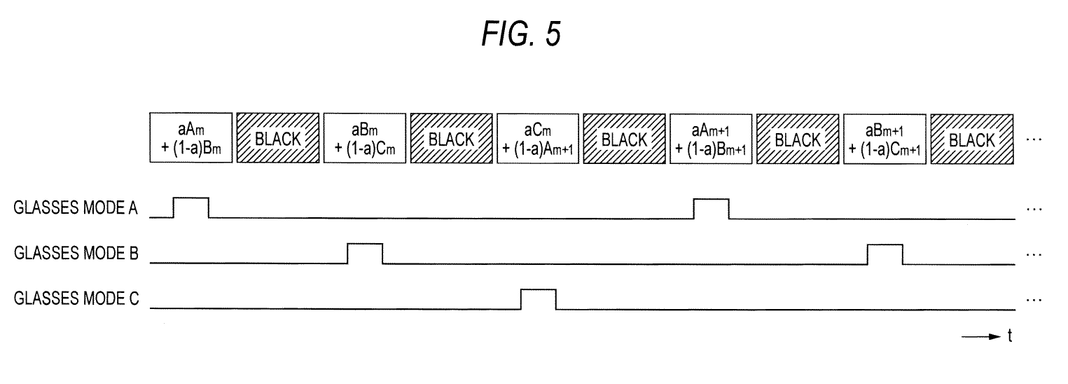

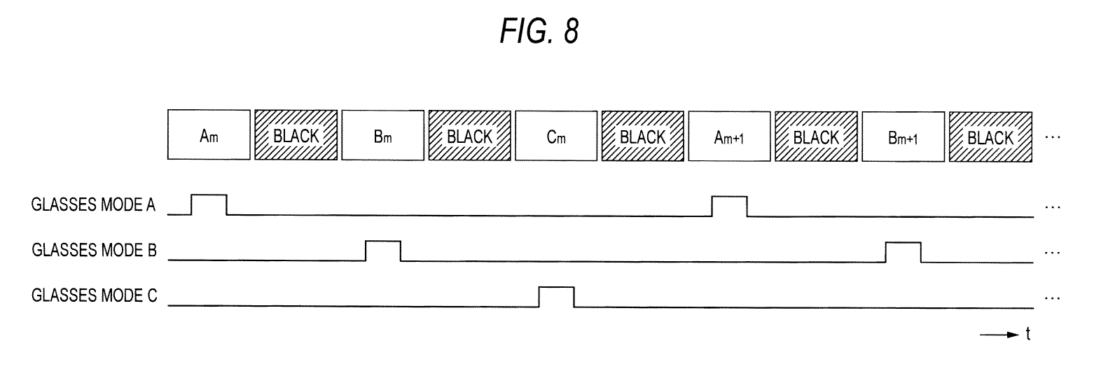

For the application of FIG. 7, in consideration of the response speed of a liquid crystal screen, an approach to reduce crosstalk might be contemplated by displaying black screens interspersed between each of the image screens (FIG. 8). However, in such cases too, a reduction in perceived crosstalk can be achieved by actuating a similar correction circuit (FIG. 5).

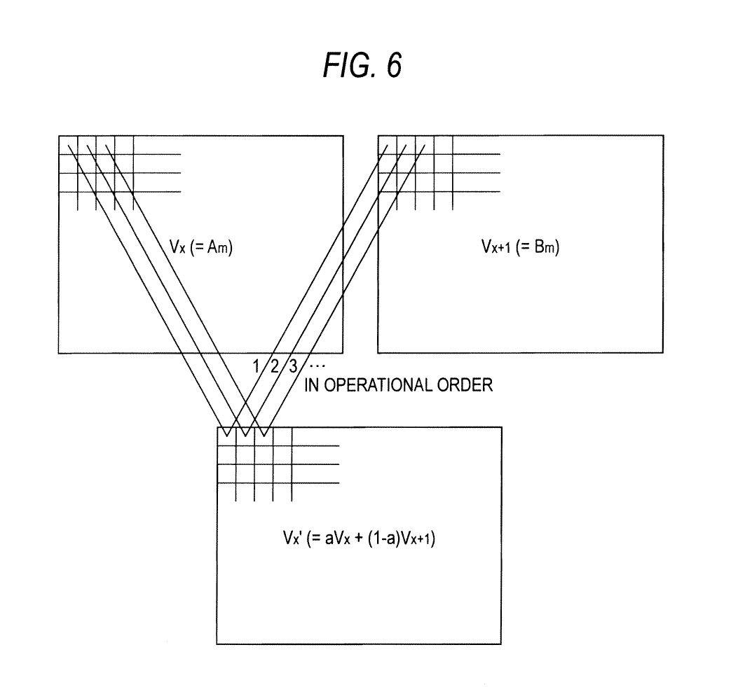

FIG. 6 is an explanatory diagram of a corrected image generation block. Each of the pixels of a previous and following screen are extracted in sequence in the horizontal direction/vertical direction by a buffer memory, for example, the parameters α and (1−α) are multiplied by each of the respective R/G/B components and then added together, and output is made of the pixels corresponding to the corrected image generated. The generated image is re-stored in a buffer memory as required, and preparation is made for output to the image output apparatus (sometimes memory is employed in common with the buffer memory of the previous stage).

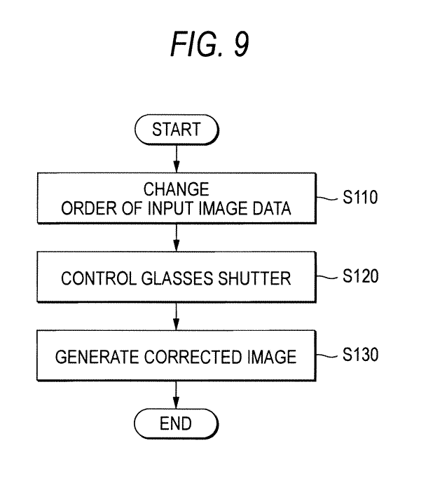

FIG. 9 is a flow chart of a multi-view system of an exemplary embodiment. Focusing on the controller 261 and the video processor 258, first the order of the input image data is changed (step S110).

Then, a glasses shutter control signal is generated (step S120). A corrected image is generated and output in synchronization with this signal (step S130).

As an application of the above exemplary embodiment, image data of screens several in screens advance can be employed as input for the corrected image generation block 6, and a parameter according to macro-changes of the screen can be applied. Fluctuations in the images can be suppressed thereby, even when the coloring of images not subject to viewing has changed by a large degree.

The value of parameter a may also be varied and not fixed. This is expected to be effective when, for example, there has been a large change after successive similar coloring. The parameter α may also be varied within a single “glasses mode” period.

Explanation has been given of a configuration, in a multi-view system in which different images are output under time division from the same image output apparatus and a desired video image can be selectively viewed by utilizing shutter glasses, for controlling output images themselves to avoid crosstalk by comparing previous and following images and changing to a nearer coloring.

Preferably configuration is provided with a mechanism that can set or input a parameter α for realizing such a configuration. As means thereof, configuration may be made with an interaction mechanism in which, for example, the operation panel 116, the remote controller 117, and/or a menu screen of the video display device 114 are employed.

By application of the present exemplary embodiment, crosstalk can be reduced between images of different colorings that exceed the response characteristics of a liquid crystal screen, and more easily viewed images can be provided. In particular, the exemplary embodiment may be utilized in fields where the presence or absence of crosstalk is of greater importance than high or low image quality (such as in computer game screens). Various contents can be utilized as the image input A, the image B and the image input C, such as, in addition to contents supplied by broadcast, from USB devices, DVDs, and contents supplied through networks.

While certain embodiment has been described, the exemplary embodiment has been presented by way of example only, and is not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image output apparatus comprising:
an image data order-change module configured to input images from a plurality of systems, to change the order of the images, and to output the images continuously;
a glasses shutter controller configured to generate a signal synchronized to an output of the images; and
a corrected image generation block configured to correct the images such that coloring of successive images approaches each other.

2. The apparatus of claim 1, wherein the corrected image generation block is configured to correct each component of R/G/B by computing using a parameter.

3. The apparatus of claim 2, wherein the parameter is changed between successive output periods of the images or in the single output.

4. The apparatus of claim 1 further comprising:
a video display device configured to successively display the corrected images.

5. An image output method in a multi-view system, the image output method comprising:
inputting images from a plurality of systems, changing the order of the images and outputting the images;
generating a signal synchronized to each of the output images; and
correcting the images such that coloring of successive images approaches each other.
